(19) United States
(12) Patent Application Publication
(10) Pub. No.: US 2020/0000130 A1
(43) Pub. Date: Jan. 2, 2020

(54) RECIPE-BASED COOKING AID

(71) Applicant: BSH HAUSGERAETE GMBH, MUENCHEN (DE)

(72) Inventor: MATTHIAS ROECKL, OTTOBRUNN (DE)

(21) Appl. No.: 16/334,794

(22) PCT Filed: Sep. 4, 2017
(86) PCT No.: PCT/EP2017/072074

§ 371 Date: Mar. 20, 2019

(30) Foreign Application Priority Data
Sep. 20, 2016 (DE) 10 2016 218 016.9

(51) Int. Cl. A23L 5/10; A47J 36/32

(52) U.S. Cl. CPC A23L 5/15; A23V 2002/00; A47J 36/321

(57) ABSTRACT

A recipe has a multiplicity of process steps and transition conditions that are respectively associated with the process steps. A method for processing such a recipe includes the following steps: determining a current process step of the recipe and a transition condition that is associated therewith; outputting an item of information depending on the current process step; scanning a parameter the value of which controls the satisfaction of said transition condition; and setting a subsequent process step of the recipe to be the current process step if the transition condition has been satisfied.

The invention relates to a recipe-based cooking aid. The invention relates, in particular, to a technique for assisting an operator when cooking a dish.

### PRIOR ART

A recipe, in particular a cooking or baking recipe, comprises a sequence of process steps in order to cook a predetermined dish. Traditionally, recipes are brought together in cook books, the handling thereof being awkward when dealing with dishes and ingredients. A recipe may also be displayed on a washable electronic display device, for example for hygienic reasons.

EP 2 556 778 B1 discloses a kitchen machine having a touch-screen display on which process steps of a recipe may be displayed.

Known techniques generally display one or more process steps at the same time and provide only a small degree of flexibility in order to cater for a user's needs. Known integrated solutions are generally limited to a single predetermined device which is designed to execute or to assist with a process step, for example by kneading, stirring or grating.

An object of the present invention is to specify an improved technique which in a flexible manner assists a user during the cooking of a dish based on a recipe. The invention achieves this object by means of the subjects of the independent claims. The subclaims disclose preferred embodiments.

### DISCLOSURE OF THE INVENTION

A recipe comprises a number of process steps as well as transition conditions that are associated with each of these. A method for processing the recipe comprises the steps of determining a current process step of the recipe and a transition condition that is associated therewith; outputting an item of information depending on the current process step; scanning a parameter, the value of which controls the satisfaction of said transition condition; and setting a subsequent process step of the recipe to be the current process step if said transition condition has been satisfied.

In contrast to conventional recipe-based techniques, an event-controlled transition may take place between one process step and the next. In particular, the transition may be automatically triggered if the parameter satisfies the transition condition. As a result, even complex sequences may be modeled which, for example, comprise branchings, loops or concurrencies. In one embodiment only one process step is handled at a time, and in a further embodiment even a number of process steps may be handled concurrently. Each execution step may be handled independently of the other or the execution steps may be combined together causally or logically.

In a first variant, the information comprises a control instruction for a controllable kitchen appliance, wherein the method comprises a step of controlling the kitchen appliance. Preferably, the kitchen appliance is not limited to a specific model but a general interface is provided via which any, or even a number of, kitchen appliances may be controlled. Thus an oven may be preheated or an extractor hood switched on, for example, in a predictive manner. If a kitchen appliance is not present, an alternative process step or an alternative transition condition may be used. The recipe may thus be adapted dynamically and optionally interactively to a set of appliances of a user.

In particular, in this variant the parameter may relate to an operating state of the kitchen appliance. For example, the parameter may relate to the temperature of an oven and a transition condition may be satisfied if the temperature has reached a value of 220° C. The monitoring of the kitchen appliance may be at least partially automated so that a user may be significantly relieved of stress when cooking dishes.

In a second variant which is able to be combined with the first variant, the information is directed to a user, wherein the output relates to textual, graphical, acoustic or haptic information. Different information channels (visual, acoustic, haptic) may also be combined together and the user may select a preferred information channel.

In a further embodiment, the parameter comprises the lapse of a predetermined time period. Thus, for example, a cooking time or a resting time of a dish or an intermediate product may be automatically monitored. The start of the time period may be linked to a predetermined event, for example the completion of a predetermined process step. The end of the time period may be monitored by means of a timer.

In particular, a time-controlled process is particularly suitable for concurrent implementation. In other words, a further process step may be carried out during the passing of the predetermined time period. If the time period has passed, the current process step may be interrupted in order to carry out a process step which follows the passing of the time period and permits no delay. For example, a process step of peeling or cutting may be interrupted by the process step of removing a bowl from an oven.

In a further embodiment, the transition condition comprises the addition of a specific quantity of an ingredient into a container, wherein the scanning of the parameter comprises determining the weight of the container. It is further preferred if a gradual progression of reaching the transition condition is offered to a user, for example in an optical, acoustic or haptic manner. If, for example, a predetermined quantity of sugar is to be added to a bowl of flour, an acoustic indicator which indicates the quantity of sugar already added may be emitted during the adding process, for example. To this end, for example, a beep may be modulated in terms of pitch and/or frequency depending on a quantity added. If the quantity to be added is exceeded by more than a predetermined amount, a corresponding error signal may be output.

In a further embodiment, the transition condition comprises an alteration to the consistency of an ingredient in a container due to the influence of mechanical processing. In this case, the parameter comprises vibrations of the container and based on a frequency distribution of the vibrations it may be determined whether the transition condition has been satisfied. If the process step comprises whipping cream or kneading a dough, for example, a progression of the mechanical processing of the ingredient may be determined by using the distribution of vibration frequencies of the container. The more compact or tough the ingredient is, the more dominant low-frequency signals may be. Thus the consistency of the ingredient may be determined in a simple and efficient manner in order to be able to transfer to a subsequent process step in good time.

It is further preferred if a user input is scanned and, depending on the user input, a process step of the recipe is set as the current process step. The scanning and processing of the user input is preferably possible at any time. Thus, for example, a process step may be repeated, skipped or altered. Also a selection of different available process steps may be offered to a user, one thereof being able to be selected by the user. Thus different variants of the recipe may be assisted dynamically in an improved manner.

Advantageously, the scanning of the user input preferably comprises the scanning of an acoustic signal. In particular, it is preferred if the user expresses the input by speech, i.e. by a spoken word, command or sequence of sounds. As a result, a control is possible even from some distance, the user does not have to use hands as an aid and simple or complex instructions may be facilitated. A simple instruction comprises, for example, the renewed acoustic output of information directed to the user. A more complex instruction, for example, may relate to a subsequent increase in a quantity of the dish to be prepared or a modification of the recipe.

A device for processing the above-described recipe comprises a storage apparatus for storing the recipe; a processing apparatus which is designed to determine a current process step of the recipe and as well as a transition condition that is associated therewith; and to output information depending on the current process step. Moreover, the device comprises a scanning apparatus for a parameter, the value of which controls the satisfaction of said transition condition. In this case, the processing apparatus is also designed to set a subsequent process step of the recipe to be the current process step if said transition condition has been satisfied.

The processing apparatus may, in particular, comprise a programmable microcomputer or microcontroller which is designed to execute at least part of the above-described method. The method in this case may, in particular, be expressed as a computer program product with program coding means.

The invention has been described with reference to a method and a device. Unless indicated otherwise, the features of the method are similarly able to be applied to the device.

The invention is now described in more detail with reference to the accompanying figures, in which:

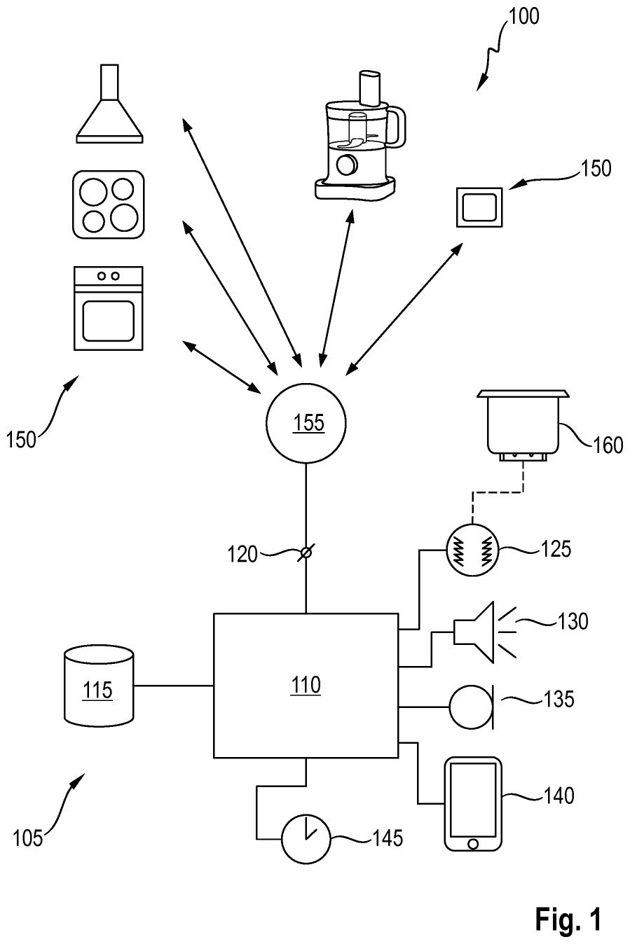

FIG. 1 shows a system having a device for processing a recipe;

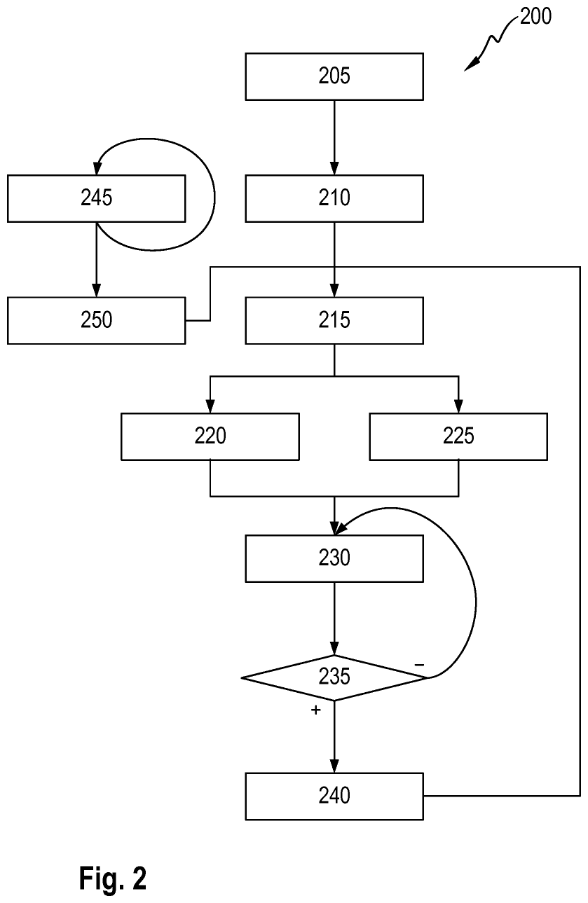

FIG. 2 shows a flow diagram of a method for processing a recipe; and

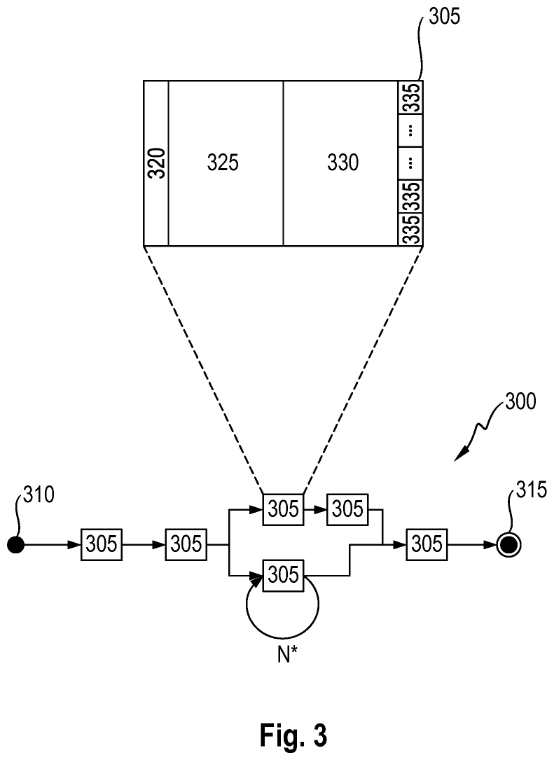

FIG. 3 shows a view of a recipe having a number of process steps.

FIG. 1 shows a system 100 having a device 105 for processing a recipe. The device 105 comprises a processing apparatus 110 and a storage device 115. In further preferred embodiments, an interface 120, a vibration sensor or vibration generator 125, an acoustic output apparatus 130, an acoustic input apparatus 135, an optical output apparatus 140, which may be designed to be integrated with a haptic input apparatus, or a timer 145 may be additionally provided. In the embodiment shown, by way of example the optical output apparatus 140 may be shown as part of a smartphone. In a further embodiment, the remaining components of the device 105 are also encompassed by the smartphone and/or designed to be integrated therewith.

The interface 120 may, in particular, comprise a wireless interface via which a connection may be made to a kitchen appliance 150. In the exemplary view of FIG. 1, by way of example an oven, a stove, an extractor hood, a cutting or kneading tool and a microwave oven are shown as kitchen appliances 150. Other or additional kitchen appliances 150 may also be provided. The kitchen appliances 150 in each case are designed to accept a request from an external component and then to control the operating state thereof. Moreover, a current operating state of a kitchen appliance 150 may be retrieved and/or read. The kitchen appliances 150 may be managed directly or via a central component 155 in order, for example, to manage rights of access, logical mutual exclusions of operating states or previous operating states. An embodiment of the central component 155 is known by the name BSH Home Connect Server. In other embodiments, however, the central component 155 may also be dispensed with. The interface 120 may also lead to one of the kitchen appliances 150 by means of a wired network.

The vibration sensor 125 may be coupled mechanically to a container 160, in particular a bowl, wherein the container 160 may be used to receive ingredients of a dish or a meal which is to be cooked based on a recipe. To this end, it is generally not necessary that the container 160, as in the case of an integrated kitchen machine, is an integral component of a processing system. Instead, the container 160 may be designed to keep the ingredient ready for any processing.

The vibration sensor 125 is designed to scan vibrations of the container 160 which, in particular, are produced during mechanical processing of the ingredient. The processing apparatus 110 may analyze these vibrations in order to determine, in particular, a consistency of the ingredient. To this end, the vibrations which are scanned, namely by means of a discrete Fourier transform, may be broken down into their frequency components and these may then be analyzed. In a further embodiment, based on the scanned vibrations, for example, it may be determined whether stirring, whipping or kneading is being carried out at an advantageous speed or not.

In a further embodiment, a vibration may be generated by means of the device 105, said vibration being transmitted via the mechanical coupling to the container 160, so that when the container 160 is in front of an operator or the operator optionally holds down the container with one hand, the operator may receive the signal in a simple manner.

The acoustic output apparatus 130 is preferably designed to output signals, sounds and, in particular, synthetically generated or spoken speech. As a result, a user of the device 105 may be informed in a simple manner about a status or an activity to be carried out. Similarly, the acoustic input apparatus 135 is preferably designed to receive noises, sounds and, in particular, spoken speech. The processing apparatus 110 may be designed to analyze the scanned speech and to illustrate this speech on a user input which then correspondingly considers this speech. The interaction of the device 105 with the user, controlled by the processing apparatus 110, may be of particular importance for the successful use of the device 105.

The optical output apparatus 140 is preferably designed to be capable of producing graphics, to be self-illuminating and/or multicolored. By means of the output apparatus 140, in particular, textual or graphical information may be provided. If the output apparatus 140 is coupled to a haptic input apparatus, this is also called a touch-screen. The haptic input apparatus 140 in this case may be used as a sensor of a set of scales. To this end, the container 160 may be placed on the input apparatus 140 and this input apparatus placed on a substrate. If the input apparatus 140 is designed to trigger actuations of different intensities in an analog manner or in a number of steps, based on the intensity of the pressure of the container 160 on the input apparatus 140, the processing apparatus 110 may obtain information about a weight of the container 160 and/or its contents. In a further embodiment, a separate set of scales is provided which, in particular, may be coupled to the device 105 by means of the interface 120. Moreover, the other input or output apparatuses shown may be produced separately in different embodiments and, in particular, connected to the processing apparatus 110 by means of the interface 120.

FIG. 2 shows a flow diagram of a method 200 for processing a recipe by means of the system 100 of FIG. 1. It should be noted that the steps shown may be executed in different embodiments and also in a different sequence. Further modifications are also possible. The method 200 may be executed at least partially by means of the device 105 and further preferably by means of the processing apparatus 110. To this end, the method 200 may be present as a computer program product. The above-described variants and embodiments of the device 105 also apply expediently to the method 200 and vice-versa.

In a first step 205 a recipe is selected. This step is superfluous if no more than one recipe is stored in the storage device 115. Optionally the recipe may also be configured in step 205, for example by an input relative to which of a number of possible variants is to be implemented, how many people or portions the recipe is to be used for, and so on. Conventional steps of calculating or determining a list of ingredients, replacing specific ingredients with substitute ingredients, etc. may also be executed in step 205.

In a step 210 preferably an internal pointer is set to a first process step of the recipe. As is described in more detail below with reference to FIG. 3, the recipe comprises a series of process steps, wherein a transition condition is assigned to each process step, said transition condition having to be satisfied in order to continue with a following process step. In the present case, by way of example a pointer is used for addressing the current process step, in other embodiments the respective current process step may also be addressed and/or selected in a different manner.

In a step 215 the current process step is provided. To this end, the process step may be downloaded from the storage device 115 and optionally additional information, for example graphics or text, retrieved from the storage device 115.

Hereinafter, in a step 220 information which is oriented to a user of the device 105 may be output. This information may, in particular, be of graphical, textual or acoustic nature. In this case, the user may, in particular, be informed as to which activity has to be executed within the context of the current process step.

In a step 225 a control command may be output, in particular via the interface 120 and further preferably to a domestic appliance 150. The steps 220 and 225 may be executed alternatively if the current process step only relates to one of the aforementioned options. The steps may also be executed together in order to link the control of one of the household appliances 150, in particular, to information of the user.

In a step 230 a parameter is determined. This parameter may, in particular, be determined by means of the haptic input apparatus 140, the acoustic input apparatus 135, the vibration sensor 125 or the timer 145, or received via the interface 120. The transition condition assigned to the current process step is formulated based on the scanned parameter so that the value of the scanned parameter decides whether the transition condition has been satisfied or not. In further embodiments, a number of parameters which may be compared with a number of threshold values may also be provided, wherein the conventional Boolean operators (AND, OR, NOT, etc.) may be used for logical linking in order to formulate and/or determine the transition condition.

In a step 235, it is checked whether the transition condition has been satisfied. If this is not the case the method 200 may return to step 230 and proceed further. In a further variant, the method 200 may also return to one of the steps 220, 225. This is advantageous, in particular, if the step 220 comprises an output of information which refers to the parameter determined in step 230, for example. As a result, it may be signaled to a user to what degree the transition condition has already been satisfied.

If in step 235 it has been determined that the transition condition has been satisfied, however, in a step 240 the above-described pointer may be set to a following process step before the method 200 returns to step 215. As a result, effectively the following process step may be set as the current process step and the depicted processes proceed once again.

It is preferred if, in particular, in a concurrent part of the method 200 a user input is scanned and evaluated. To this end, in the embodiment shown, in a step 245 a user input is scanned and analyzed, in particular by means of the acoustic input device 135 or the haptic input device 140. In particular, it may be determined that the input refers to a wish of the user to alter the current process step. For example, the user may wish to start the current process step once again. In this case, in a step 250 the described pointer may be set to the desired process step and the method 200 continues in step 215. The concurrent part of the steps 245 and 250 may proceed once again independently thereof.

FIG. 3 shows a schematic view of a recipe 300 having process steps 305. The recipe 300 generally comprises a number of process steps 305 which form a specific sequence between a start state 310 and an end state 315. An exemplary embodiment of one of the process steps 305 is shown enlarged. In this case, the fields shown are purely of exemplary nature.

A first field 320 may carry a sequential number or address of the process step 305. A process step 305 may be identified clearly using its number 320. The pointer, described above with reference to FIG. 2, may contain the number 320 in order to address a process step 305.

A further field 325 comprises information which has to be output in the context of the process step 305. This information, in particular as control information, may be directed to one of the domestic appliances 150 or one of the peripheral appliances 125 to 145 or to a user. A combination of these variants is also possible. In particular, information which is directed to the user may comprise additional data, for example as graphics or a video sequence.

A further field 330 preferably comprises a transition condition. The transition condition is preferably formulated such that it comprises an expression which may be evaluated by using a parameter, wherein the value of the expression may adopt one of two binary values, one thereof being expressed as true and the other as false. In this case, different binary interim results may also be combined by means of Boolean algebra. Generally, the determination of whether the transition condition has been satisfied comprises the comparison of a value of a scanned parameter with a predetermined threshold value.

Moreover, in a preferred embodiment one or more further fields 335 may be provided, in each case said further fields identifying which process step 305 is intended to be the logically following process step. In this case, a number of process steps 305 may also follow one another logically. To this end, the recipe 300 may either be branched, namely based on the value of the transition condition in the field 330, or a number of concurrent partial sequences may be generated.

These concepts are able to be identified in the embodiment of the recipe 300 shown by way of example. In a further possible embodiment, one of the process steps 305 may also be executed, in particular N times. The transition condition 330 in this case may comprise a local counter variable, the value thereof being implemented or decremented with each execution of the step 305.

Further flow control measures are also possible. For example, the user may be prompted to make a choice at a branching of a number of process steps 305 following a process step 305.

### REFERENCE CHARACTERS

100 System
105 Device
110 Processing apparatus
115 Storage device
120 Interface
125 Vibration sensor or vibration generator
130 Acoustic output apparatus
135 Acoustic input apparatus
140 Optical output apparatus optionally with haptic input apparatus
145 Timer
150 Kitchen appliance
155 Central component
160 Container
200 Method
205 Select recipe
210 Pointer to first process step
215 Retrieve process step
220 Output user information
225 Output control command
230 Scan parameter
235 Transition condition satisfied?
240 Pointer to following process step
245 Scan user input
250 Set process step
300 Recipe
305 Process step
310 Start state
315 End state
320 Number
325 Information
330 Transition condition
335 Further fields

1-10. (canceled)

11. A method for processing a recipe, the recipe having a plurality of process steps and respectively associated transition conditions, the method comprising:
determining a current process step of the recipe and a transition condition associated with the current process step;
outputting an item of information in dependence on the current process step;
scanning a parameter a value of which controls a satisfaction of the transition condition associated with the current process step; and
when the parameter indicates that the transition condition has been satisfied, defining a subsequent process step of the recipe to be the current process step.

12. The method according to claim 11, wherein the information comprises a control instruction for a controllable kitchen appliance and the method further comprises controlling the kitchen appliance according to the control instruction.

13. The method according to claim 11, wherein the parameter relates to an operating state of the kitchen appliance.

14. The method according to claim 11, wherein the information comprises data directed to a user, and the method comprises outputting the data to the user by text, graphically, acoustically or haptically.

15. The method according to claim 11, wherein the parameter relates to a lapse of a predetermined time period.

16. The method according to claim 11, wherein the transition condition comprises an addition of a specific quantity of an ingredient into a container and the step of scanning the parameter comprises determining a weight of the container.

17. The method according to claim 11, wherein the transition condition comprises an change to a consistency of an ingredient in a container caused by mechanical processing and the parameter relates to vibrations of the container, and the method comprises determining, based on a frequency distribution of the vibrations of the container, whether the transition condition has been satisfied.

18. The method according to claim 11, which comprises scanning a user input and, depending on the user input, setting a process step of the recipe as the current process step.

19. The method according to claim 18, wherein scanning the user input comprises scanning an acoustic signal.

20. A device for processing a recipe, the recipe including a plurality of process steps and transition conditions respectively associated with the process steps, the device comprising:
a memory apparatus for storing the recipe;
a processing apparatus configured to determine a current process step of the recipe and a transition condition that is associated with the current process step;
a scanning apparatus for scanning a parameter, the value of which controls a satisfaction of the transition condition;
said processing apparatus being configured to output information depending on the current process step; and
said processing apparatus being configured to set a subsequent process step of the recipe to become the current process step when the transition condition has been satisfied.
